(19) United States
(12) Patent Application Publication
(10) Pub. No.: US 2014/0091056 A1
(43) Pub. Date: Apr. 3, 2014

(54) MANUFACTURING METHOD OF PHASE RETARDATION FILM AND MANUFACTURING SYSTEM CONFIGURED TO PRODUCE PHASE RETARDATION FILM

(71) Applicant: Industrial Technology Research Institute, Hsinchu (TW)

(72) Inventors: Chia-Tai Chen, Hsinchu County (TW); Po-Fu Yen, Taipei City (TW)

(73) Assignee: Industrial Technology Research Institute, Hsinchu (TW)

(21) Appl. No.: 14/093,057

(22) Filed: Nov. 29, 2013

Related U.S. Application Data
(63) Continuation-in-part of application No. 13/113,072, filed on May 22, 2011.

(30) Foreign Application Priority Data
Mar. 21, 2011 (CN) 201110071643.1

(51) Int. Cl. G02B 1/12

(52) U.S. Cl. CPC G02B 1/12
USPC 216/24; 156/345.11

(57) ABSTRACT

A manufacturing method of a phase retardation film is provided. A flexible light-transmissive substrate is provided. The flexible light-transmissive substrate is aligned to form an alignment substrate. A birefringent material film is formed on the alignment substrate. A reaction-causing light is used to expose and induce a reaction on a first patterned region of the birefringent material film. A second patterned region of the birefringent material film is not exposed by the reaction-causing light. The second patterned region of the birefringent material film is removed. A manufacturing system configured to produce a phase retardation film is also provided.

### CROSS-REFERENCE TO RELATED APPLICATION

This application is a continuation-in-part application of and claims the priority benefit of a prior application Ser. No. 13/113,072, filed on May 22, 2011, now pending. The prior application Ser. No. 13/113,072 claims the priority benefit of China application serial no. 201110071643.1, filed on Mar. 21, 2011. The entirety of each of the above-mentioned patent applications is hereby incorporated by reference herein and made a part of this specification.

### TECHNICAL FIELD

The disclosure relates to a manufacturing method of a phase retardation film and a manufacturing system configured to produce a phase retardation film.

### BACKGROUND

The year of 2010 has been internationally established as the year of stereoscopic display. According to statistical prediction, the global stereoscopic display market will increase 95% each year in the future. Accordingly, display manufacturers successively enter the market of stereoscopic display. Due to such a demand, flat display device has entered another era, which is the era of stereoscopic display.

A stereoscopic display may realistically show an image desired to be conveyed, as a natural image being viewed by the eyes of a human being. Conventionally, a stereoscopic display applies an exteriorly mounted micro-phase retardation film, formed with a special polymer material. The micro-phase retardation film is attached to the glass of the exterior of a liquid crystal screen. When a light signal image passes through the liquid crystal switch of the display device and the attached micro-phase retardation film, a phase change is generated. Accordingly, after being filtered by polarized glasses, two different types of image information are formed and are respectively provided for the viewing of the left and right eyes. Due to the innate parallax phenomenon of human beings, two dissimilar images ultimately form a stereoscopic image in the brain.

A stereoscopic display device can be differentiated into the glasses-wearing type and the auto-stereoscopic type, wherein each type of stereoscopic display device has its advantages and disadvantages, and appropriate applications. The exterior-attached micro-phase retardation film method may be applied to the glasses-wearing type of stereoscopic display device. However, the fabrication method of a micro-phase retardation film typically requires two or more photomask processes. Hence, the manufacturing process is more complicated, and the fabrication cost and time can not be effectively lowered.

### SUMMARY

An exemplary embodiment of the disclosure provides a manufacturing method of a phase retardation film. The manufacturing method comprises: providing a flexible light-transmissive substrate; aligning the flexible light-transmissive substrate to form an alignment substrate; forming a birefringent material film on the alignment substrate; exposing and inducing a reaction on a first patterned region of the birefringent material film by a reaction-causing light, wherein a second patterned region of the birefringent material film is not exposed by the reaction-causing light; and removing the second patterned region of the birefringent material film.

An exemplary embodiment of the disclosure provides a manufacturing system configured to produce a phase retardation film. The manufacturing system comprises a plurality of rollers, an aligning unit, a coater, an exposing unit, and an etching unit. The rollers are configured to transfer a flexible light-transmissive substrate along a transferring path. The aligning unit is disposed on the transferring path and configured to align the flexible light-transmissive substrate. The coater is disposed on the transferring path after the flexible light-transmissive substrate passing the aligning unit and configured to coat a birefringent material film on the flexible light-transmissive substrate. The exposing unit is disposed on the transferring path after the flexible light-transmissive substrate passing the coater and configured to expose and induce a reaction on a first patterned region of the birefringent material film by a reaction-causing light. A second patterned region of the birefringent material film is not exposed by the reaction-causing light. The etching unit is disposed on the transferring path after the flexible light-transmissive substrate passing the exposing unit and configured to remove the second patterned region of the birefringent material film.

Several exemplary embodiments accompanied with figures are described in detail below to further describe the disclosure in details.

### BRIEF DESCRIPTION OF THE DRAWINGS

The accompanying drawings are comprised to provide further understanding, and are incorporated in and constitute a part of this specification. The drawings illustrate exemplary embodiments and, together with the description, serve to explain the principles of the disclosure.

FIGS. 1A to 1F are schematic diagrams showing the steps of a manufacturing method for a phase retardation film according to an exemplary embodiment.

FIG. 2 is a schematic diagram showing a manufacturing method of a stereoscopic display device according an exemplary embodiment.

FIG. 3 is a schematic diagram showing the stereoscopic display device of FIG. 2 displaying the stereoscopic image.

FIG. 4 is a schematic cross-sectional view of a manufacturing system according to an exemplary embodiment and is also a schematic view showing a manufacturing method of a phase retardation film according to an exemplary embodiment.

FIGS. 5A-5C is schematic cross-sectional view showing parts of the steps of the manufacturing method of FIG. 4.

### DETAILED DESCRIPTION OF DISCLOSED EMBODIMENTS

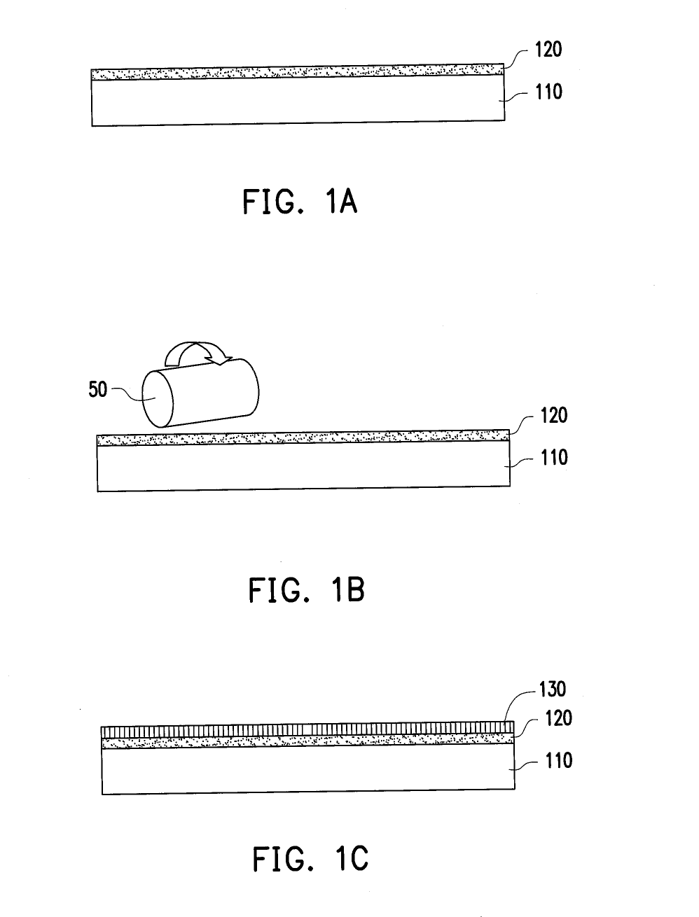

FIGS. 1A to 1F are schematic diagrams showing the steps of a manufacturing method for a phase retardation film according to an exemplary embodiment. The manufacturing method of a phase retardation film according to an exemplary embodiment comprises at the least the following steps. As shown in FIG. 1A, a light-transmissive substrate 110 is provided. In this exemplary embodiment, the light-transmissive substrate 110 is, for example, a transparent substrate, such as a glass substrate. However, in the other exemplary embodiments, the light-transmissive substrate may be constructed with other materials.

Thereafter, an alignment layer 120 is formed on the light-transmissive substrate 110. In this exemplary embodiment, the material of the alignment layer 120 comprises polyimide, for example. More specifically, a layer of polyimide alignment liquid is spin-coated on the light-transmissive substrate 110. Other approaches may also be applied to coat the polyimide alignment liquid. Thereafter, the alignment liquid is heated and cured to form the alignment layer 120.

Referring to FIG. 1B, the alignment layer 120 is aligned. In this exemplary embodiment, the method of aligning the alignment layer 120 comprises, for example, a rubbing alignment method, in which a roller 50 having fine hair thereon is applied to roll and sweep the surface of the alignment layer 120. In this exemplary embodiment, as the roller 50 sweeps the alignment layer 120, the rolling direction of the roller 50 maintains substantially unchanged. Hence, the alignment layer 120 may be aligned along a single direction. However, in other exemplary embodiments, the alignment layer 120 may be aligned by an optical alignment method, wherein when light irradiates the alignment layer 120 in a particular direction, the alignment layer 120 is also aligned along a single direction.

Thereafter, as shown in FIG. 1C, a birefringent material film 130 is formed on the alignment layer 120. In this exemplary embodiment, the birefringent material film 130 is a reactive mesogen material film, for example. Then, as shown in FIG. 1D, a reaction-causing light 60 is used to expose to the first patterned region 132 of the birefringent material film 130 so as to generate a reaction, while the second patterned region 134 is not exposed by reaction-causing light 60. More particularly, in the current exemplary embodiment, the reaction-causing light 60 is an ultraviolet light, for example. The reaction-causing light 60 may be emitted from a light source. Further, a photomask 70 may be disposed between the birefringent material film 130 and the above light source, wherein the photomask 70 comprises a patterned light-transmissive region 72 and a patterned light-shielding region 74. The reaction-causing light 60 penetrates the patterned light-transmissive region 72 and irradiates the first patterned region 132, such that an exposure reaction is generated in the first patterned region 132. On the other hand, the patterned light-shielding region 74 shields the reaction-causing light 60 from irradiating the second patterned region 134. Accordingly, the second patterned region 134 is not exposed.

In this exemplary embodiment, the first patterned region 132 comprises a plurality of mutually separated, first strip-shaped regions 133, and the second patterned region 134 comprises a plurality of mutually separated, second strip-shaped regions 135. The first strip-shaped regions 133 and the second strip-shaped regions 135 are alternately arranged on the light-transmissive substrate 110. More specifically, each of the first strip-shaped regions 133 extends along a second direction D2, and each of the second strip-shaped regions 135 also extends along the second direction D2, while the first strip-shaped regions 133 and the second strip-shaped regions 135 alternately arranged in the first direction D1. In this exemplary embodiment, the first direction D1 is substantially perpendicular to the second direction D2.

Further, in this exemplary embodiment, using the reaction-causing light 60 to expose and to induce a reaction on the first patterned region 132 of the birefringent material film 130 is basically using the reaction-causing light 60 to expose and cure the first patterned region 132. In other words, the reactive mesogen material adopted for the birefringent material film 130 is a photocuring material. In this embodiment, the step of curing the first patterned region 132 by the reaction-causing light 60 is solidifying the first patterned region 132 by the reaction-causing light 60.

Continuing to FIG. 1E, the second patterned region 134 of the birefringent material film 130 is then removed. In this exemplary embodiment, the second patterned region 134 of the birefringent material film 130 is removed by performing a wet etching process on the second patterned region 134. More specifically, the wet etching process is performed by submerging the light-transmissive substrate 110 along with the alignment layer 120, the exposed first patterned region 132, and the unexposed second patterned region 134 in an alcohol solvent 90 or other type of solvent to remove the second patterned region 134 from the light-transmissive substrate 110. For example, the light-transmissive substrate 110 along with the alignment layer 120, the exposed first patterned region 132, and the unexposed second patterned region 134 is placed in a container 92 containing an alcohol solvent 90 and is soaked in the alcohol solvent 90. However, in other exemplary embodiments, removing the second patterned region 134 of the birefringent material film 130 may be accomplished by performing drying etching on the second patterned region 134 to remove the second patterned region 134. Referring to FIG. 1F, after the second patterned region 134 is removed, the phase retardation film 100 of this exemplary embodiment is completed.

In this exemplary embodiment, the phase retardation film 100 comprises a light-transmissive substrate 110, an alignment layer 120, a patterned birefringent material film (which is the above-mentioned first patterned region 132), wherein the alignment layer 120 is disposed on the light-transmissive substrate 110. In this exemplary embodiment, the alignment layer 120 has a single directionality, and the patterned birefringent material film (which is the first patterned region 132) is disposed on the alignment layer 120 and is aligned by the alignment function of the alignment layer 120. Further, the patterned birefringent material covers a portion of the alignment layer 120. In this exemplary embodiment, the patterned birefringent material comprises photo-cured reactive mesogen material. Furthermore, the patterned birefringent material (the above-mentioned first patterned region 132) comprises a plurality of strip-shaped regions (the above-mentioned first strip-shaped regions 133). These strip-shaped regions (the above-mentioned first strip-shaped regions 133) are configured along the first direction D1 and spaced apart, and each first strip-shaped region (the above-mentioned first strip-shaped region 133) extends along the second direction D2.

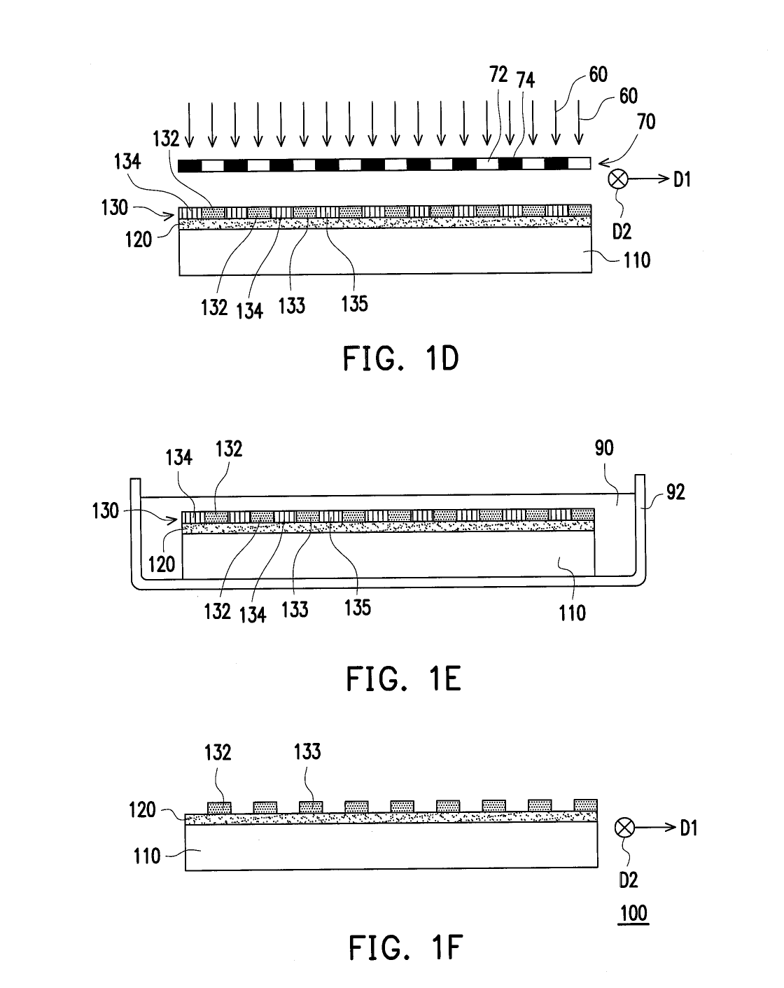

FIG. 2 is a schematic diagram showing a manufacturing method of a stereoscopic display device according an exemplary embodiment. Referring to FIG. 2, the manufacturing method of a stereoscopic display device of this exemplary embodiment comprises the above manufacturing steps of a phase retardation film 100. Moreover, the manufacturing method of a stereoscopic display device of this exemplary embodiment also comprises disposing the phase retardation film 100 on a display device 200. Alternatively speaking, the light-transmissive substrate 110, along with the alignment layer 120 and the first patterned region 132, is disposed on the display device 200, wherein an image light 210 emitted by the display device 200 is polarized. Accordingly, the fabrication of a stereoscopic display device 300 of this exemplary embodiment is completed.

In this exemplary embodiment, the display device 200 is a liquid crystal display device, which comprises a back light module 270, a first polarizer 220, an active device array substrate 230 such as a thin film transistor array substrate, and an opposite substrate 250 such as a color filter substrate disposed in sequence. In this exemplary embodiment, the opposite substrate 250 comprises a plurality of pixels 251 and these pixels 251 may be separated into two groups, which are the pixels 252 and the pixels 254. The pixels 252 correspond to the first patterned region 132, while the pixels 254 correspond to the original position of the removed second patterned region 134. In other words, the pixels 254 correspond to the gap G between two adjacent first strip-shaped regions 133 of the first patterned region 132. A first part image light 212 from the pixels 252 and through the second polarizer 260 is linearly polarized. Further, through the adjustment of the thickness of the first patterned region 132, the first patterned region 132 forms a half-wave plate. Alternatively speaking, the first patterned region 132 has a phase retardation effect of half wavelength. Moreover, the fast axis of the half-wave plate and the linear polarization direction of the first part image light 212 from the second polarizer 260 substantially form a 45-degree included angle. As such, after the first part image light 212 passes through the first patterned region 132, the linear polarization direction of the first part image light 212 is rotated by 90 degrees. On the other hand, the second part image light 214 from the pixels 254 and through the second polarizer 260 is linearly polarized, and after the second part image light 214 passes through the gap G, its linear polarization direction is unchanged. In other words, there is a 90-degree difference between the linear polarization direction of the first part image light 212 that passes through the first patterned region 132 and the linear polarization direction of the second part image light 214 that passes through the gap G. Accordingly, the pixels 252 display one of the left-eye and right-eye images, while the pixels 254 display another one of the left-eye and right-eye images. A user who is wearing a polarized glasses, which comprises a right-eye polarized lens and a left-eye polarized lens having transmission axes different in 90 degrees, can view the stereoscopic image displayed by the stereoscopic display device.

According to the manufacturing methods of a phase retardation film and the manufacturing method of a stereoscopic display, device of these exemplary embodiments of the disclosure, a single photomask process may be applied to complete the phase retardation film; hence, the manufacturing method of a phase retardation film and the manufacturing method of a stereoscopic display device are simplified. Further, the manufacturing cost and time are effectively reduced. Moreover, a high temperature process can be obviated. Additionally, the gap G is formed after the removal of the second patterned region 134, so that the positioning of the first patterned region 132 and the gap G is precise. In another exemplary embodiment, the photomask process is not applied to expose the first patterned region 132. Instead, a laser light source may apply to scan the first patterned region 132 and not the second patterned region 134 in order to expose the first patterned region 132. Accordingly, a single exposure process is performed; hence, a simple manufacturing process is resulted, and the manufacturing time and cost are effectively reduced. Moreover, the structure of the phase retardation film 100 of the exemplary embodiment is simple; the manufacturing cost is thereby lower.

In another exemplary embodiment, the display device 200 may be an organic light emitting diode display (OLED display), a plasma display panel, a cathode ray tube or other appropriate display devices having a polarizer film disposed on a display panel.

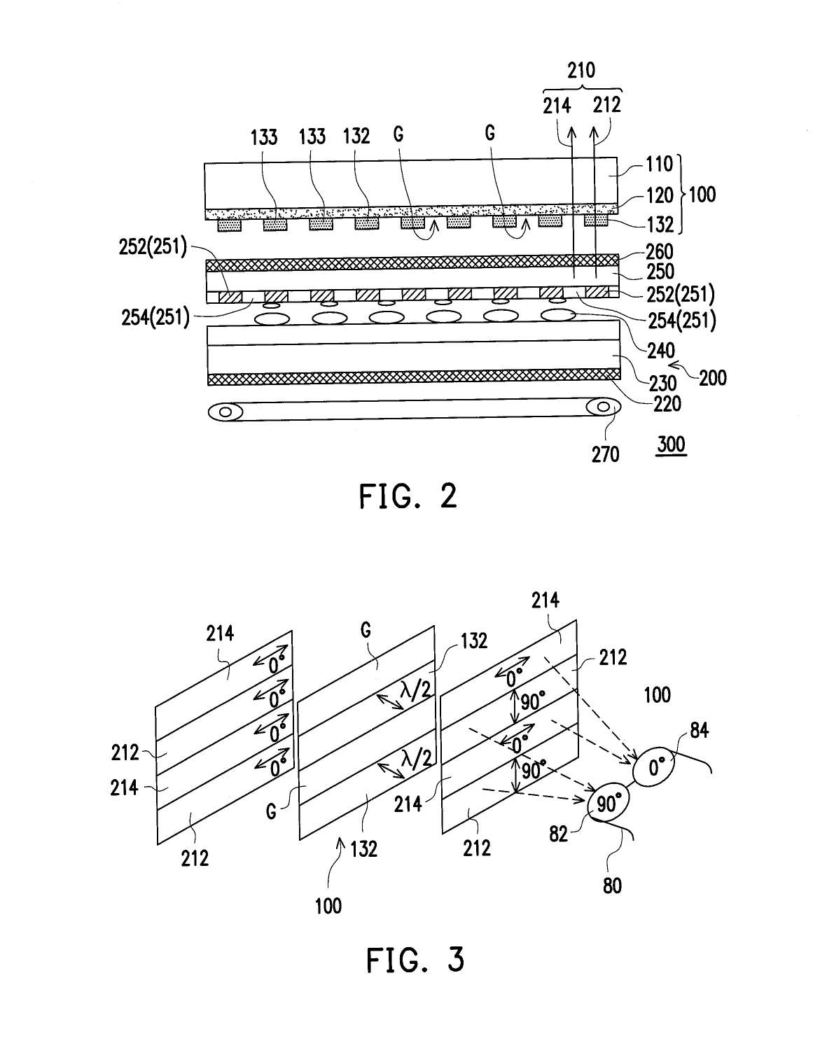

The following exemplary embodiment illustrates the liner polarization direction of the image light at the different stages, the direction of the phase retardation film, and polarization direction of the polarized glasses worn by a user. The exemplary embodiment is only used as an illustration and should by no means be used to limit the scope of the disclosure. FIG. 3 is a schematic diagram showing the stereoscopic display device of FIG. 2 displaying the stereoscopic image. Referring to both FIGS. 2 and 3, the image light 210 just emitted from the display device 200 is distributed as the quadrilateral shown at the leftmost side in FIG. 3, wherein the linear polarization directions of the first part image light 212 and the second part image light 214 are 0 degree, for example. Then, the first part image light 212 passes through the phase retardation film 100. The first patterned region 132 is, for example, a half-wave plate, and the fast axis direction thereof and the liner polarization direction of the just emitted image light 210 forms a 45-degree included angle, for example. Accordingly, after the image light 210 passes through the phase retardation film 100, the first part image light 212 has a 90-degree linear polarization direction due to its passage through the first patterned region 132, while the second part image light 214 has a 0-degree linear polarization direction due to its passage through the gap G, as in the quadrilateral shown at the rightmost side in FIG. 3. The transmission axis of the left-eye polarized lens of the polarized glasses 80 worn by a user is set at a 90-degree direction, for example; while the transmission axis of the right-eye polarized lens 84 of the polarized glasses 80 is set at a 0-degree direction. Accordingly, the left eye of the user sees the first part image light 212, but not the second part image light 214. Whereas the right eye of the user sees the second part image light 214, but not the first part image light 212. Therefore, if the first part image light 212 comprises the information of the left-eye image and the second part image light 214 comprises the information of the right-eye image, the user can view a stereoscopic image.

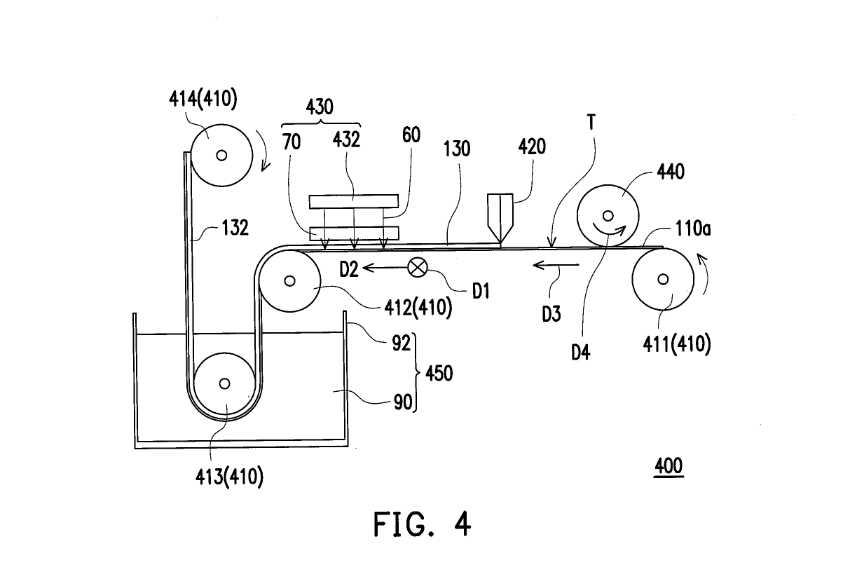

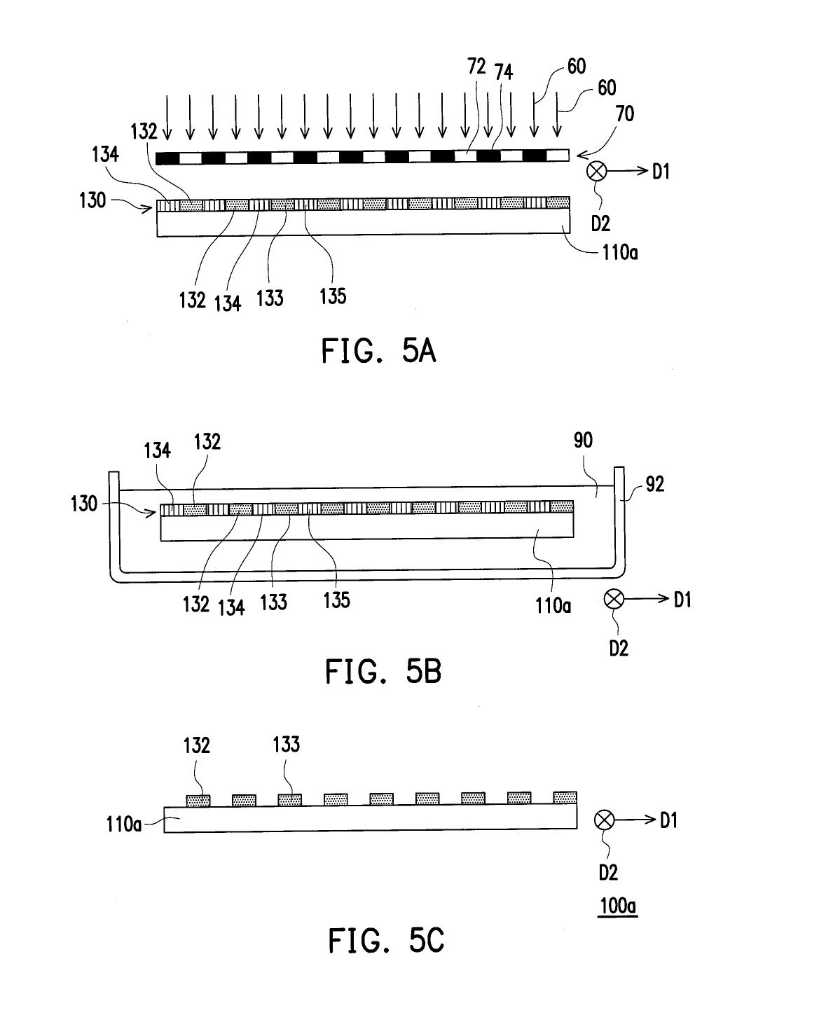

FIG. 4 is a schematic cross-sectional view of a manufacturing system according to an exemplary embodiment and is also a schematic view showing a manufacturing method of a phase retardation film according to an exemplary embodiment. FIGS. 5A-5C is schematic cross-sectional view showing parts of the steps of the manufacturing method of FIG. 4. Referring to FIGS. 4 and 5A-5C, the manufacturing method in this embodiment is similar to the manufacturing method shown in FIGS. 1A-1F, and the difference therebetween is as follows. The manufacturing method in this embodiment may be performed by the manufacturing system 400 in this embodiment. The manufacturing system 400 in this embodiment is configured to produce a phase retardation film 100a. The manufacturing system 400 comprises a plurality of rollers 410, for example, the rollers 411, 412, 413, and 414, an aligning unit 440, a coater 420, an exposing unit 430, and an etching unit 450. The rollers 410 are configured to transfer a flexible light-transmissive substrate 110a along a transferring path T. For example, the flexible light-transmissive substrate 110a is transferred along the direction D3 and along the transferring path T.

The aligning unit 440 is disposed on the transferring path T and configured to align the flexible light-transmissive substrate 110a. The material of the flexible light-transmissive substrate 110a is capable of being aligned. For example, the flexible light-transmissive substrate 110a is made of polyethylene terephthalate_(PET), triacetate cellulose (TAC), cyclo olefin polymers (COP) or polycarbonate (PC). In this embodiment, the aligning unit 440 is a rubbing roller configured to rub the light-transmissive 110a along a direction D4 to form an alignment substrate.

The coater 420 is disposed on the transferring path T after the flexible light-transmissive substrate 110a passing the aligning unit 440 and configured to coat a birefringent material 130 on the flexible light-transmissive substrate 110a. The birefringent material 130 in FIG. 4 may be the same as the birefringent material 130 shown in FIG. 1C. Since the flexible light-transmissive substrate 110a is aligned, the birefringent material 130 is aligned by the flexible light-transmissive substrate 110a.

The exposing unit 430 is disposed on the transferring path T after the flexible light-transmissive substrate 110a passing the coater 420 and configured to expose and induce a reaction on a first patterned region 132 of the birefringent material film 130 by a reaction-causing light 60. A second patterned region 134 of the birefringent material film 130 is not exposed by the reaction-causing light 60.

In this embodiment, the reaction-causing light 60 and the photomask 70 in FIGS. 4 and 5A are the same as the reaction-causing light 60 and the photomask 70 shown in FIG. 1D. Specifically, the exposing unit 430 comprises an exposing light source 432 and a photomask 70. The exposing light source 432 is configured to provide the reaction-causing light 60. The photomask 70 is disposed on the path of the reaction-causing light 60 between the exposing light source 432 and the transferring path T and comprises a patterned light-transmissive region 72 corresponding to the first patterned region 132 and a patterned light-shielding region 74 corresponding to the second patterned region 134.

In this embodiment, the first patterned region 132 comprises a plurality of mutually separated, first strip-shaped regions 133, and the second patterned region 134 comprises a plurality of mutually separated, second strip-shaped regions 135. The first strip-shaped regions 133 and the second strip-shaped regions 135 are alternately arranged on the flexible light-transmissive substrate 110a. More specifically, each of the first strip-shaped regions 133 extends along a second direction D2, and each of the second strip-shaped regions 135 also extends along the second direction D2, while the first strip-shaped regions 133 and the second strip-shaped regions 135 alternately arranged in the first direction D1. In this exemplary embodiment, the first direction D1 is substantially perpendicular to the second direction D2.

The etching unit 450 is disposed on the transferring path T after the flexible light-transmissive substrate 110a passing the exposing unit 430 and configured to remove the second patterned region 134 of the birefringent material film 130. The etching unit comprises an etchant, for example, the alcohol solvent 90 shown in FIG. 1E, and a container. The etchant (the alcohol solvent 90) is configured to etch out the second patterned region 134 of the birefringent material film 130 so as to form the phase retardation film 100a. The container 92 is configured to containing the etchant.

In this embodiment, the flexible light-transmissive substrate 110a is rolled out from the roller 411, and is rolled up by the roller 414.

The manufacturing method of the phase retardation film 100a in this embodiment comprises the following steps. First, the flexible light-transmissive substrate 110a is provided. In this embodiment, the flexible light-transmissive substrate 110a is transferred in a roll-to-roll maner. Then, the flexible light-transmissive substrate 110a is aligned to form an alignment substrate. For example, the flexible light-transmissive substrate 110a is aligned by the aligning unit 440. Next, the birefringent material film 130 is formed on the alignment substrate (i.e. the aligned flexible light-transmissive substrate 110a). Afterwards, the reaction-causing light 60 is used to expose and induce the reaction on the first patterned region 132 of the birefringent material film 130, wherein the second patterned region 134 of the birefringent material film 130 is not exposed by the reaction-causing light 60. This step may be performed by the exposing unit 430. Specifically, this step comprises exposing and curing the first patterned region 132 by the reaction-causing light 60. For example, the step of curing the first patterned region 132 by the reaction-causing light 60 is solidifying the first patterned region 132 by the reaction-causing light 60. Then, the second patterned region 134 of the birefringent material film 130 is removed, and this step may be performed by the etching unit 450, and the phase retardation film 100a is then produced and rolled up by the roller 414. Specifically, the step of removing the second patterned region 134 of the birefringent material film 130 comprises performing the wet etching process on the second patterned region 134. In detail, the wet etching process comprises soaking the alignment substrate, the exposed first patterned region 132, and the unexposed second patterned region 134 in the alcohol solvent 90.

In this embodiment, a flexible phase retardation film 100a may be formed in a roll-to-roll manner, so that the process time of the manufacturing method is reduced, thereby increasing the throughput and reducing the cost.

According to the manufacturing method of a phase retardation film and the manufacturing method of a stereoscopic display device of the exemplary embodiments of the disclosure, a single photomask process may be used to complete the phase retardation film. Hence, the manufacturing method of a phase retardation film and the manufacturing method of a stereoscopic display device are simplified, and the manufacturing cost and time are effectively reduced. Moreover, a high temperature process can be obviated. Additionally, the gap is formed after the removal of the second patterned region, so that the positioning of the first patterned region and the gap are precise. In another exemplary embodiment, the photomask process may not be used to expose the first patterned region. Instead, a laser light source may be applied to scan the first patterned region and not the second patterned region in order to expose the first patterned region. Accordingly, a single exposure process is performed; hence, a simple manufacturing process is resulted, and the manufacturing time and cost are also effectively reduced. Moreover, the structure of the phase retardation film of the exemplary embodiment is simpler; the manufacturing cost is thereby lower. In an exemplary embodiment, a flexible phase retardation film may be formed in a roll-to-roll manner, so that the process time of the manufacturing method is reduced, thereby increasing the throughput and reducing the cost.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A manufacturing method of a phase retardation film, the manufacturing method comprising:
providing a flexible light-transmissive substrate;
aligning the flexible light-transmissive substrate to form an alignment substrate;
forming a birefringent material film on the alignment substrate;
exposing and inducing a reaction on a first patterned region of the birefringent material film by a reaction-causing light, wherein a second patterned region of the birefringent material film is not exposed by the reaction-causing light; and
removing the second patterned region of the birefringent material film

2. The manufacturing method of claim 1, wherein the step of aligning the flexible light-transmissive substrate to form the alignment substrate comprises rubbing the alignment substrate along a direction to form the alignment substrate.

3. The manufacturing method of claim 1, wherein the alignment substrate is aligned along a single direction.

4. The manufacturing method of claim 1, wherein the birefringent material film comprises a reactive mesogen material film.

5. The manufacturing method of claim 1, wherein the step of exposing and inducing the reaction on the first patterned region of the birefringent material film by the reaction-causing light comprises exposing and curing the first patterned region by the reaction-causing light.

6. The manufacturing method of claim 5, wherein the step of curing the first patterned region by the reaction-causing light is solidifying the first patterned region by the reaction-causing light.

7. The manufacturing method of claim 1, wherein the step of removing the second patterned region of the birefringent material film comprises performing a wet etching process on the second patterned region.

8. The manufacturing method of claim 7, wherein the wet etching process comprises soaking the alignment substrate, the exposed first patterned region, and the unexposed second patterned region in an alcohol solvent.

9. The manufacturing method of claim 1, wherein the first patterned region comprises a plurality of first strip-shaped regions separate from each other, and the second patterned region comprises a plurality of second strip-shaped regions separate from each other, and the plurality of first strip-shaped regions and the plurality of the second strip-shaped regions are alternately arranged on the light-transmissive substrate.

10. The manufacturing method of claim 1 further comprising transferring the light-transmissive substrate in a roll-to-roll manner.

11. A manufacturing system configured to produce a phase retardation film, the manufacturing system comprising:
a plurality of rollers configured to transfer a flexible light-transmissive substrate along a transferring path;
an aligning unit disposed on the transferring path and configured to align the flexible light-transmissive substrate;
a coater disposed on the transferring path after the flexible light-transmissive substrate passing the aligning unit and configured to coat a birefringent material film on the flexible light-transmissive substrate;
an exposing unit disposed on the transferring path after the flexible light-transmissive substrate passing the coater and configured to expose and induce a reaction on a first patterned region of the birefringent material film by a reaction-causing light, wherein a second patterned region of the birefringent material film is not exposed by the reaction-causing light; and
an etching unit disposed on the transferring path after the flexible light-transmissive substrate passing the exposing unit and configured to remove the second patterned region of the birefringent material film.

12. The manufacturing system of claim 11, wherein the aligning unit is a rubbing roller configured to rub the flexible light-transmissive substrate along a direction to form an alignment substrate.

13. The manufacturing system of claim 11, wherein the birefringent material film comprises a reactive mesogen material film.

14. The manufacturing system of claim 11, wherein the etching unit comprises:
an etchant configured to etch out the second patterned region of the birefringent material film; and
a container configured to containing the etchant.

15. The manufacturing system of claim 14, wherein the etchant is an alcohol solvent.

16. The manufacturing system of claim 11, wherein the exposing unit comprises:
an exposing light source configured to provide the reaction-causing light; and
a photomask disposed on a path of the reaction-causing light between the exposing light source and the transferring path and comprising a patterned light-transmissive region corresponding to the first patterned region and a patterned light-shielding region corresponding to the second patterned region.
